(19) United States
(12) Patent Application Publication
(10) Pub. No.: US 2013/0029302 A1
(43) Pub. Date: Jan. 31, 2013

(54) PSYCHIATRIC ASSESSMENT BY PRE-SCREENING AND CORRELATION OF UNDERLYING PHYSICAL CONDITIONS

(71) Applicant: Jill Joyce, Millersville, MD (US)

(72) Inventor: Jill Joyce, Millersville, MD (US)

(21) Appl. No.: 13/561,613

(22) Filed: Jul. 30, 2012

Related U.S. Application Data
(60) Provisional application No. 61/512,618, filed on Jul. 28, 2011.

(51) Int. Cl. G09B 19/00

(52) U.S. Cl. 434/236

(57) ABSTRACT

An improved method for pre-screening for underlying physiological conditions prior to psychiatric assessment. The method comprises the steps of administering a predetermined battery of tests including blood tests, urine tests and genetic tests, entering test results in a form, and differentially correlating the entered test results to underlying physical conditions relevant to a symptomatic psychiatric disorder. The pre-screening allows a correct diagnosis of the physical condition rather than a misdiagnosis of some neurological condition that is merely symptomatic of the physical condition. The invention may be implemented in a computer architecture using software.

### CROSS-REFERENCE TO RELATED APPLICATION(S)

The present application derives priority from U.S. Provisional Patent Application No. 61/512,618 filed 28 Jul. 2012.

### BACKGROUND OF THE INVENTION

1. Field of the Invention

The present invention relates to improvements in psychiatric patient screening and diagnosis and, particularly, to a method for psychiatric assessment by pre-screening for underlying neurotoxic disorders, metabolic/endocrine disorders, genetic issues, disease and other physical root causes of psychiatric disorder, and correlation of underlying physical conditions to said psychiatric disorder.

2. Description of the Background

A psychiatric assessment, or psychological screening, is a process of gathering information about a person within a psychiatric (or mental health) service, with the purpose of making a diagnosis. The assessment is usually the first stage of a treatment process. Such assessments are often inconclusive and only lead to more comprehensive psychiatric testing. It is well-recognized that many psychiatric disorders are often caused by underlying physiological problems such as neurotoxic disorders, metabolic/endocrine disorders, genetic issues, disease and the like. However, typical treatment of psychiatric illness assumes that the illnesses with similar symptoms have similar causes and that there are only a few causes of psychiatric illness. That is not true. In some cases, during a battery of psychiatric testing, the results will begin to point to some underlying physiological cause. However, this often takes a great deal of physician skill and experience to recognize and pursue this line of thinking.

There are many post-screening approaches to correlate specific psychiatric symptoms to particular physical issues when neurologic findings are not conclusive.

For example, Brett et al., “Screening For Vitamin B12 Deficiency In Psychiatric Patients”, J Gen Intern Med. 1994 September; 9(9):522-4 explains how psychiatric patients are frequently screened for vitamin B12 deficiency in the absence of hematologic or other neurologic findings. The authors suggest post-screening for vitamin B12 deficiency in the absence of hematologic or other neurologic findings.

At least three companies—Neuromark, Psynomics, and SureGene—are offering genetic tests for variants associated with mental illness. Neuromark's Mark-C test examines two genetic markers, GRIK2 and GRIA3, that appear to increase the risk of suicidal thoughts in people taking antidepressant drug Celexa™. Psynomic's Psynome™ tests for two mutations in the GRK3 gene associated with bipolar disorder. SureGene™ has developed the AssureGene™ test that examines a panel of (unspecified) genes and markers that is being marketed to aid in the diagnosis of patients at risk of developing psychosis.

The concept of pre-screening for physiological root causes has been discussed generally. Garden, Gill, “Physical examination in psychiatric practice”, Advances in Psychiatric treatment, 11: 142-149 (2005) suggests that a thorough physical examination should be an integral part of a comprehensive psychiatric assessment because physical illnesses are more common in people with mental disorders. However, Gill merely suggests a somewhat nebulous series of tests with no proximate correlation to neurological systems.

Other physiological approaches to psychiatric assessment include United States Patent Application 20100009325 by Afanasiev et al. which shows a psychological method for testing or subconsciously teaching a subject by visual subconscious stimulus.

U.S. Pat. No. 6,053,866 to McLeod issued Apr. 25, 2000 shows a method for facilitating diagnosis of a psychiatric disorder by questionnaire in a format which facilitates recording the patient's answers and establishing a preliminary disorder indication based on the answers.

U.S. Pat. No. 6,245,021 to Stampfer (HeartLink) issued Jun. 12, 2001 shows a method for diagnosing psychiatric disorders comprising the steps of measuring the pattern of a subject's heart rate, and using said pattern to diagnose the psychiatric disorder. Also disclosed is a method for assessing the effectiveness of a treatment for a psychiatric disorder, comprising measuring a heart rate pattern of a subject before treatment, measuring a heart rate pattern of the subject during treatment, and comparing the patterns for changes to determine the effectiveness of the treatment.

United States Patent Application 20080124688 by Kay published May 29, 2008 shows an automated protocol for determining psychiatric disability based on various assessments (stress, social, activity) and combining the results to determine psychiatric status.

To illustrate the problem, vitamin deficiency is linked to psychiatric symptoms but the result is usually sub-clinical, meaning that vitamin levels are too low to maintain proper health, but sufficient to prevent classic clinical symptoms of deficiency. Moreover, vitamins interact with each other and an imbalance may not be attributable to any one vitamin. This makes it difficult for a clinician to detect such deficiencies when they exist, and virtually impossible when the clinician is a psychiatrist looking for the cause of mental symptoms. Having a blood test is the definitive way of detecting vitamin deficiencies, but in a psychological setting this is often a last resort. It would save time, trouble and considerable expense to deliver a battery of physiological tests prior to a standard psychiatric evaluation, if only the results could be adequately correlated to neurological disorders. None of the foregoing references proposes an extensive battery of physiological testing prior to a standard psychiatric evaluation, and a software tool for concrete correlation of the battery results to prescreen for neurological disorder. What is needed is a predetermined battery of tests to yield a matrix of physiological test results, and a weighted analysis/correlation of said matrix to neurological diagnoses that is capable of software implementation.

### SUMMARY OF THE INVENTION

It is, therefore, an object of the invention to provide a system and method of psychiatric assessment by pre-screening for underlying neurotoxic disorders, metabolic/endocrine disorders, genetic issues, disease and other physical root causes of psychiatric disorder, and a software tool for correlation of underlying physical conditions to said psychiatric disorder.

It is a more specific object to provide a predetermined battery of tests to yield a matrix of physiological test results, plus a weighted analysis/correlation of said matrix to neurological diagnoses that is capable of software implementation.

In accordance with the foregoing object, the present invention provides an improved method for pre-screening for underlying physiological conditions prior to psychiatric assessment. The method comprises the steps of administering a predetermined battery of tests including group of blood, urine, stool and hair tests that are designed to detect physiological causes of psychiatric illness, entering test results in a database, and differentially correlating the entered test results to underlying physical conditions relevant to a symptomatic psychiatric disorder. The pre-screening allows a correct diagnosis of the physical condition rather than a misdiagnosis of some neurological condition that is merely symptomatic of the physical condition. The invention may be implemented in a computer architecture using software.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram of an exemplary application service provider (ASP) network for embodying the present method in software form.

FIG. 2 is a screen print of the data entry form for the battery of physiological tests according to the present invention.

FIG. 3 is an example of entries in the Differential Diagnosis Ruleset used by the analytical engine of the present invention.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is a method of pre-screening for underlying neurotoxic disorders, metabolic/endocrine disorders, genetic issues, disease and other physical root causes prior to a psychiatric assessment. The method entails administering a predetermined battery of tests to yield a matrix of physiological test results. The matrix of physiological test results is subjected to a deductive analysis using weighted scoring and is automatically correlated to specific neurological diagnoses. The entire method is capable of software implementation using a rule-based artificial intelligence engine.

The invention is herein implemented in the context of an application service provider (ASP) computer network to facilitate client use of the present method in software form.

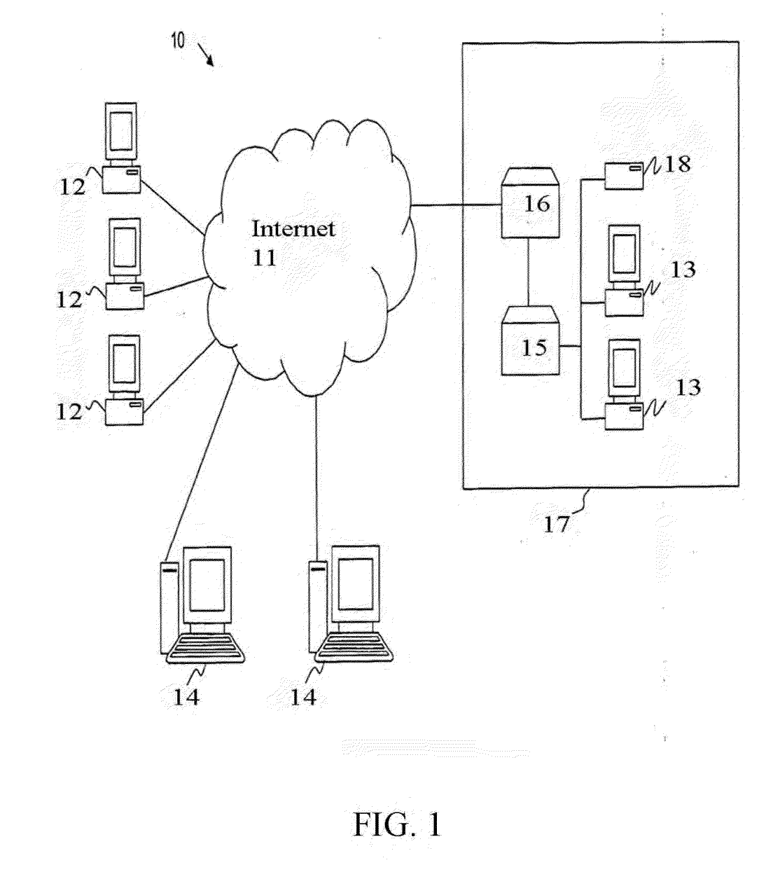

As shown in FIG. 1, ASP network 10 may include a plurality of clients 12 and servers 14 connected via the internet 11. Any number of clients 12 and servers 14 may participate in such a network 10. The system further includes at least one ASP local area network 17 (“LAN”) for hosting and allowing administration of the system by administrators using ASP clients. The internet or World Wide Web provides a known system for interconnecting clients 12, servers 14 and ASP LAN 17 in a communicating relationship. However, other networks may be used, such as satellite networks, the Public Switched Telephone Network, WiFi networks, WiMax networks, cellular networks, and any other public, private, or dedicated networks that might be used to interconnect devices for transfer of data.

Physician users will typically access the system via a client 12, and an exemplary client 12 may include a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, digital subscriber line (“DSL”) card, cable modem, network interface card, wireless network card, or other interface device capable of wired, fiber optic, or wireless data communications. One example of such a client 12 is a personal computer equipped with an operating system such as Microsoft Windows, UNIX, or Linux, along with software support for Internet communication protocols. The client 12 preferably includes at least one browser program, such as Microsoft Internet Explorer, Google Chrome™, Netscape Navigator™, FireFox™ or the like to provide a user interface for access to the software.

Corporate (hospital or other health care provider) users will typically access the system via a server 14, and an exemplary server 14 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic and may include separate servers for different functions. Such servers may further include one or more mass storage devices such as a disk farm or a redundant array of independent disk (“RAID”) system for additional storage and data integrity. Suitable servers and mass storage devices are manufactured by, for example, Compaq®, IBM®, and Sun Microsystems®. Server 14 runs an enterprise operating system such as Sun®, Oracle Solaris® or the like, and uses a standard HTTP server, such as Apache®.

ASP LAN 17 comprises a plurality of ASP clients 13 clustered together to handle more client traffic and including one or more mass storage devices such as a disk farm or a redundant array of independent disk (“RAID”) system for additional storage and data integrity. The ASP local area network 17 (“LAN”) interconnects ASP clients 13 through a hub 15 (for example, a peer network such as a wired or wireless Ethernet network) or a local area network server (in, for example, a client-server network). The ASP LAN 17 is preferably connected to the internet 11 through a secure gateway 16, which provides HIPPA-compliant security to the ASP LAN 17 and ensures operating compatibility between the ASP LAN 17 and the internet 11. An exemplary ASP client 13 may include a processor, a memory (e.g. RAM), a bus which couples the processor and the memory, a mass storage device (e.g. a magnetic hard disk or an optical storage disk) coupled to the processor. The present invention is data intensive, and at least one ASP server 18 in ASP LAN 17 is a database server running database management software to provide database services to ASP LAN 17 and user clients 12 and servers 14, as defined by the ASP client-server model. Database management systems frequently provide database server functionality, and some DBMSs (e.g., MySQL) rely exclusively on the client-server model for database access. Thus, ASP server 18 preferably hosts a network database preferably an SQL server database, running MySQL. Other examples of Database servers are Oracle, DB2, Informix, Ingres, SQL Server. Secure communication lines are used between clients 12, servers 13 and ASP LAN 17 so that private data remains so.

The secure gateway 16 may be a Citrix Access Gateway® for securing the delivery of healthcare information and populating data to user clients 13 and servers 14 anywhere. Gateway 16 provides security to the ASP LAN 17 and ensures operating compatibility between the ASP LAN 17 and the internet 11.

The ASP server 18 hosts a hosts a web server which delivers data-entry capability to the software by transmitting web pages in hypertext markup language (HTML) or extensible markup language (XML) (or a similar scheme) using the hypertext transport protocol (http) to any of clients 12, 13 or servers 14. The physician administers the predetermined battery of tests (described below) and enter the results in a spreadsheet-like matrix of physiological test result data stored in ASP server 18 network database. The ASP server 18 also hosts the analytical rules-based decision engine of the present invention, plus a network SQL database which is populated with the rules employed by the decision engine, as will be described. Data extracted from other health-related databases may be used to populate the SQL database. When data entry of the physiological test results is complete, the analytical rules-based decision engine subjects said results to a weighted analysis using the SQL database rules, and correlates the test results to specific neurological diagnoses.

The method of the present invention will now be described in detail. Physician users administer the predetermined battery of tests and enter the results via client 12 in a spreadsheet-like matrix of physiological test result data stored on ASP server 18 in its network database.

The battery of physiological tests comprises at least the following categorical tests: blood testing, urine testing, stool testing, and genetic screening by a hair sample. Each test including one or more different assays looking for different markers, each marker being clinically relevant to one or more known neurological conditions. As an initial step, blood and urine, plus a stool and hair sample must be collected. For this purpose each patient is supplied with a urine/stool/hair collection kit, and blood will be drawn from a vein in the arm using a needle, or via finger prick. Given the requisite samples the following tests and assays are performed.

Blood Tests

The blood test entails a laboratory analysis performed on the extracted blood sample to determine physiological and biochemical states, including at least the following tests:

I. For diseases, particularly:

a. The Venereal Disease Research Laboratory test or VDRL is a blood test for syphilis

b. Lyme disease (neurological symptoms may include fever, headache, fatigue, depression);

c. Strep antibody (linked to obsessive-compulsive disorder and/or a tic disorder, motoric hyperactivity)

d. Cushing's syndrome (Cushing's syndrome is a hormone disorder caused by high levels of cortisol in the blood, which is often manifest as various psychological disturbances, ranging from euphoria to depression and anxiety.

e. Prion Disease: Prions cause neurodegenerative disease by aggregating extracellularly within the central nervous system to form plaques known as amyloid, which disrupt the normal tissue structure. Once symptoms appear the disease progresses rapidly, leading to brain damage and death. Neurodegenerative symptoms can include convulsions, dementia, ataxia (balance and coordination dysfunction), and behavioural or personality changes.

f. Creutzfeldt-Jacob disease (CJD), a fatal neurological disorder in humans.

g. Toxoplasmosis gondii (a parasite causing behavioral changes in humans, including lower reaction times and a sixfold increased risk of traffic accidents).

h. Leukodystrophy diseases, including Fabry disease, Gaucher disease, Pompe disease, Krabbe disease, Hurler syndrome and Niemann-Pick A/B disease.

II. Amino Acid levels, and particularly:

a. Argininosuccinate Lyase Deficiency (ASA)

b. Homocystinuria (HCY) Tyrosinemia, type I (TYR I)

c. Argininosuccinate Lyase Deficiency (ASA)

d. Tyrosinemia, type I (TYR I)

e. Citrullinemia (CIT)

f. Phenylketonuria (PKU)

g. Maple Syrup Urine Disease (MSUD)

III. Metabolic Imbalance via a comprehensive metabolic panel, or chemical screen, (CMP; CPT code 80053) a panel of 14 blood tests which serves as an initial broad screening tool, and particularly:

a. methylmalonic aciduria, is an autosomal recessive metabolic disorder manifest by increased methylmalonic acid levels, which can indicate a vitamin B12 deficiency;

b. Arylsulfatase A (also known as “cerebroside-sulfatase”) (A deficiency is associated with metachromatic leukodystrophy);

c. Epinephrine and Norepinephrine (imbalance of epinephrine and norepinephrine can cause anxiety, panic attacks, depression, eating disorders, obesity, insomnia, headache, chronic pain, and fatigue); and

d. Parathyroid hormone (controls the calcium and phosphorus balances in the blood, and imbalance can cause problems with the kidneys and bones and cause changes in calcium and vitamin D levels)

IV. Vitamin/Mineral Deficiency

a. B1 (well-known syndromes caused by thiamine deficiency include beriberi and Wernicke-Korsakoff syndrome, diseases also common with chronic alcoholism.)

b. B2

c. B3 (Niacin and Metabolites)

d. B5

e. B6 (key symptoms include seizures, irritability, cheilitis (inflammation of the lips), conjunctivitis and other neurologic symptoms);

f. B12 (Anemia with bone marrow promegaloblastosis, gastrointestinal symptoms, and other neurological symptoms);

g. Vitamin A deficiency (impaired vision)

h. Vitamin B1-B12 (sensory or motor deficiencies, dementia and other psychiatric symptoms)

i. Folic Acid/Folate deficiency (loss of appetite, and weight loss, weakness, sore tongue, headaches, heart palpitations, irritability, and behavioral disorders)

j. Vitamin D deficiency (Muscle aches and weakness, muscle twitching.

k. Vitamin E deficiency (neurological problems due to poor nerve conduction, including neuromuscular problems such as spinocerebellar ataxia and myopathies, and anemia);

l. Vitamin K deficiency;

m. Fatty Acid Oxidation disorders and Organic Acid disorders (part of Acylcarnitine disorders), by an acylcarnitine profile.

V. Toxicology

Substances that may be detected on a blood toxicology screen include:
Alcohol (ethanol)—“drinking” alcohol
Amphetamines
Antidepressants
Arsenic
Barbiturates and hypnotics
Benzodiazepines
Cadmium
Cocaine
Flunitrazepam (Rohypnol)
Gamma hydroxybutyrate (GHB)
Lead
Marijuana
Mercury
Narcotics
Non-narcotic pain medicines including acetaminophen and anti-inflammatory drugs
PCP
Phenothiazines (antipsychotic or tranquilizing medications)
Prescription medications, any type

### Urine Test

A regular urine test (urinalysis) is conducted to ascertain fluid balance, diet, medicines, and diseases. Importantly, the urinalyses differentially measures some of the same above-described blood test parameters. For example, the following urinalysis assays are conducted adding both independent and differential measurement value as described:

a. Copper (Wilson disease, excess copper storage, copper poisoning, copper deficiency)

b. Xanthrurenic Acid (elevated levels in patients with vitamin B6 deficiency)

c. Zinc (zinc toxicity)

d. Thallium (toxicity)

e. Aryl Sulfatase A

f. Amino Acids Panel

g. Porphobilinogen

h. Delta Amino-Levulinic Acid

i. Osmolality, Urine

j. Toxoplasmosis gondii (above)

k. Catecholamines

l. vanillylmandelic acid (VMA)

m. pH

n. Silicon

o. Urinary Steroid Hormone Profile for various steroid deficiencies and abnormalities in steroid hormone production (various CPT Codes provide data for 30 key analytes serving as markers for major androgens, estrogens, progesterone and metabolites, and adrenal hormones and metabolites).

p. Leukodystrophy diseases, including Fabry disease, Gaucher disease, Pompe disease, Krabbe disease, Hurler syndrome and Niemann-Pick A/B disease.

Stool Sample Screening

A regular stool analysis is conducted to ascertain a diverse group of disorders caused by defects in the biosynthesis of heme and characterized by accumulations of porphyrinogens, porphyrins, and their precursors in plasma, red blood cells, tissues, urine, and feces. The stool analysis also differentially measures some of the same above-described blood test and urinalysis parameters inasmuch as accumulation of porphyrin in the feces is usually met with accumulations in plasma, red blood cells, tissues, and urine.

### Hair Sample Screening

A regular hair sample analysis is conducted to ascertain toxicity of Arsenic, Lead, or Mercury. This also differentially measures some of the same above-described blood test and urinalysis parameters.

### Genetic Screening (Optional)

Neurological disorders are known to sometimes have a genetic cause. Nevertheless, obtaining genotype information is not standard clinical practice. In accordance with the present invention one or more of the following clinically approved molecular tests may optionally be used:

Alpha-1-antitrypsin deficiency (AAT; emphysema and liver disease)

Amyotrophic lateral sclerosis (ALS; Lou Gehrig's Disease; progressive motor function loss leading to paralysis and death)

Alzheimer's disease* (APOE; late-onset variety of senile dementia)

Ataxia telangiectasia (AT; progressive brain disorder resulting in loss of muscle control and cancers)

Gaucher disease (GD; enlarged liver and spleen, bone degeneration) Inherited breast and ovarian cancer* (BRCA 1 and 2; early-onset tumors of breasts and ovaries)

Hereditary nonpolyposis colon cancer* (CA; early-onset tumors of colon and sometimes other organs)

Central Core Disease (CCD; mild to severe muscle weakness)

Charcot-Marie-Tooth (CMT; loss of feeling in ends of limbs)

Congenital adrenal hyperplasia (CAH; hormone deficiency; ambiguous genitalia and male pseudohermaphroditism)

Cystic fibrosis (CF; disease of lung and pancreas resulting in thick mucous accumulations and chronic infections)

Duchenne muscular dystrophy/Becker muscular dystrophy (DMD; severe to mild muscle wasting, deterioration, weakness)

Dystonia (DYT; muscle rigidity, repetitive twisting movements)

Emanuel Syndrome (severe mental retardation, abnormal development of the head, heart and kidney problems)

Fanconi anemia, group C (FA; anemia, leukemia, skeletal deformities)

Factor V-Leiden (FVL; blood-clotting disorder)

Fragile X syndrome (FRAX; leading cause of inherited mental retardation)

Galactosemia (GALT; metabolic disorder affects ability to metabolize galactose)

Hemophilia A and B (HEMA and HEMB; bleeding disorders)

Hereditary Hemochromatosis (HFE; excess iron storage disorder)

Huntington's disease (HD; usually midlife onset; progressive, lethal, degenerative neurological disease)

Marfan Syndrome (FBN1; connective tissue disorder; tissues of ligaments, blood vessel walls, cartilage, heart valves and other structures abnormally weak)

Mucopolysaccharidosis (MPS; deficiency of enzymes needed to break down long chain sugars called glycosaminoglycans; corneal clouding, joint stiffness, heart disease, mental retardation)

Myotonic dystrophy (MD; progressive muscle weakness; most common form of adult muscular dystrophy)

Neurofibromatosis type 1 (NF1; multiple benign nervous system tumors that can be disfiguring; cancers)

Phenylketonuria (PKU; progressive mental retardation due to missing enzyme; correctable by diet)

Polycystic Kidney Disease (PKD1, PKD2; cysts in the kidneys and other organs)

Adult Polycystic Kidney Disease (APKD; kidney failure and liver disease)

Prader Willi/Angelman syndromes (PW/A; decreased motor skills, cognitive impairment, early death)

Sickle cell disease (SS; blood cell disorder; chronic pain and infections)

Spinocerebellar ataxia, type 1 (SCA1; involuntary muscle movements, reflex disorders, explosive speech)

Spinal muscular atrophy (SMA; severe, usually lethal progressive muscle-wasting disorder in children)

Tay-Sachs Disease (TS; fatal neurological disease of early childhood; seizures, paralysis)

Thalassemias (THAL; anemias—reduced red blood cell levels)

Timothy Syndrome (CACNA1C; characterized by severe cardiac arrhythmia, webbing of the fingers and toes called syndactyly, autism).

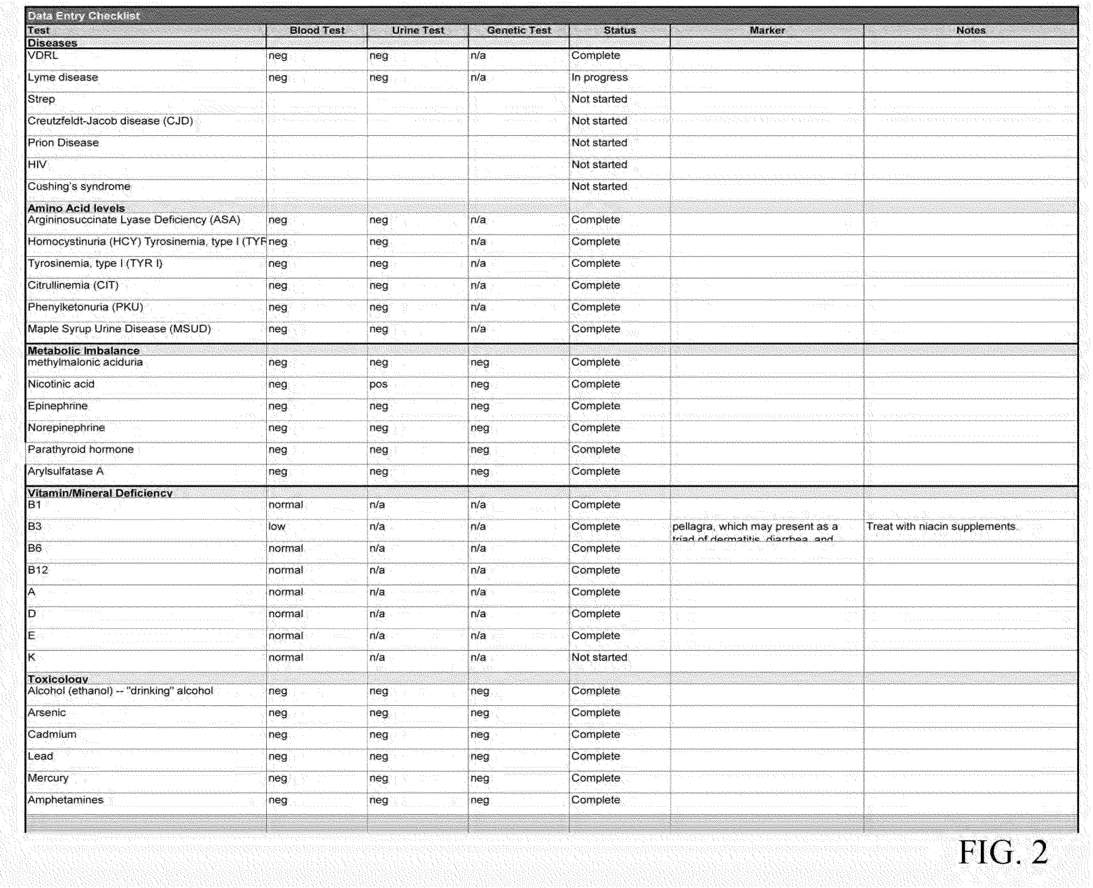

FIG. 2 is a screen print of an exemplary data entry form page for some of the above-described battery of physiological tests including blood testing, urine testing, hair and stool screening, and optionally genetic screening, each test including one or more different assays looking for different markers each clinically relevant to a known neurological condition.

After the physician administers the test battery and enters the results in the spreadsheet of FIG. 2, the ASP server 18 applies the analytical rules-based decision engine, using the ruleset stored in the network SQL database, to differentially screen for an underlying physical root cause of a neurological condition.

A unique aspect of the present invention is the method for correlating the observed complementary assay results of the physiological tests including blood testing, urine testing, hair and stool screening, and optionally genetic screening, to neurological symptoms of a patient. This is a two-step analysis, the ASP server 18 software first being configured to collect and receive the observed assay results of the patient and to correlate the observed assay results to physical symptoms which may include increase in blood pressure, increase in heart rate, increase in temperature, toxicity, increase in blood sugar level, decrease in oxygen in the blood, decrease of brain or motor activities, respiratory effects, chest pains and/or other symptoms that may be observed. The ASP server 18 software is configured to make a secondary correlation of the physical symptoms to neurological symptoms of the patient. The complementary assay results of the select blood testing, urine testing, hair and stool screening, and optionally genetic screening provide a more reliable indication of the root physiological cause of neurological symptoms and allow a very reliable pre-screening for physiological causes of psychiatric disorders.

For example, the pH of urine can vary between 4.6 and 8, with 7 being norm. In persons with hyperuricosuria, acidic urine can contribute to the formation of stones of uric acid in the kidneys, ureters, or bladder. The ASP server 18 applies the analytical rules-based decision engine to correlate a high urine pH observed by the urinalysis and presence of kidney stones in the stool sample to a build-up of uric acid in all body fluids, and to correlate the physiological symptoms to observed neurological symptoms including poor muscle control, facial grimacing, involuntary writhing, and repetitive movements of the arms and legs, resulting in physiological diagnosis of a deficiency of the enzyme hypoxanthine-guanine phosphoribosyltransferase (HGPRT).

Thus, as seen in FIG. 2 the ASP server 18 analytical rules-based decision engine includes a complete list of conditions (column 1) having a physiological origin, associated with the specific observed assay results of the patient (columns 2-4) which serve as indicators for that condition, a status column (column 5) indicating completion status of the associated assay, and the physiological illnesses (column 6) that correlate the conditions of column 1 with the indicators of columns 2-4, thereby associating one or more assay results with one or more conditions, and one or more conditions with one or more specific neurological illnesses.

Using the spreadsheet of FIG. 2 to provide a specific example, it can be seen that the urine test for Nicotinic acid was positive, and low levels of vitamin B3 were found in the blood tests. The analytical rules-based decision engine is preprogrammed to recognize that a deficit of vitamin B3 (or the amino acid tryptophan, which is converted into niacin) is differentially confirmed by Nicotinic acid in the urine. Both are present indicators in the spreadsheet of FIG. 2. The decision engine populates the marker field (column 6) with the physical condition and the associated neurological symptoms, in this case the condition being pellagra, and the neurological symptom being dementia. A corrective action may be stated in the notes, e.g., “treat with niacin supplements.”

The ruleset stored in the network SQL database comprises a library of clinical guidelines for differentially completing a diagnosis in accordance with the entered data. The analytical engine is a rule-based table of if-then type statements regarding specific conditions.

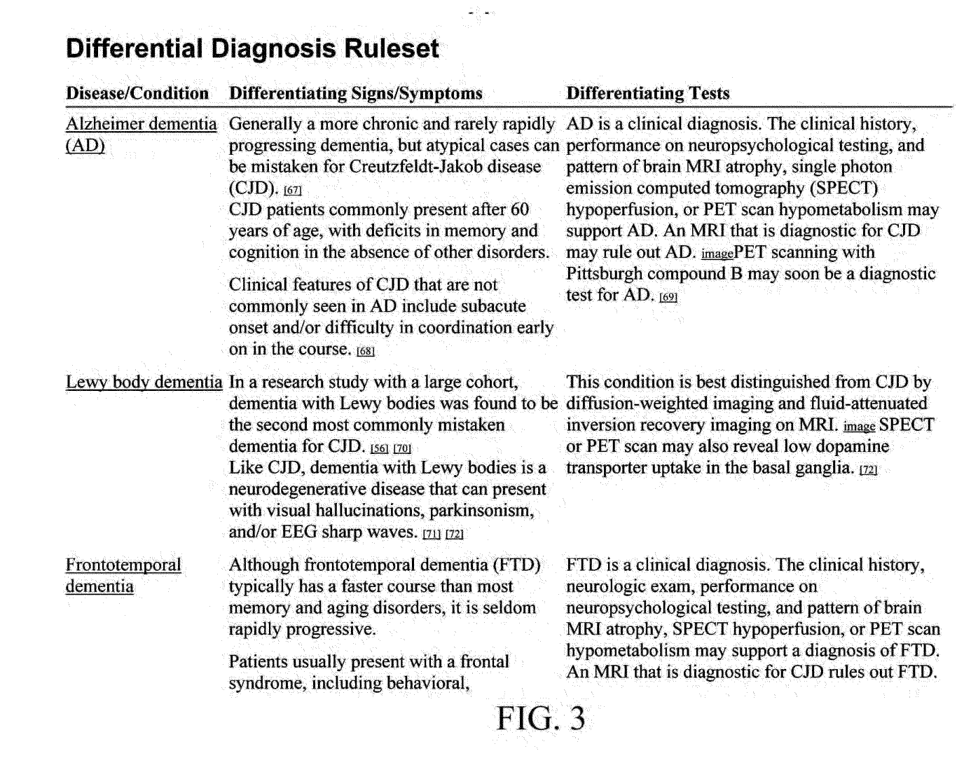

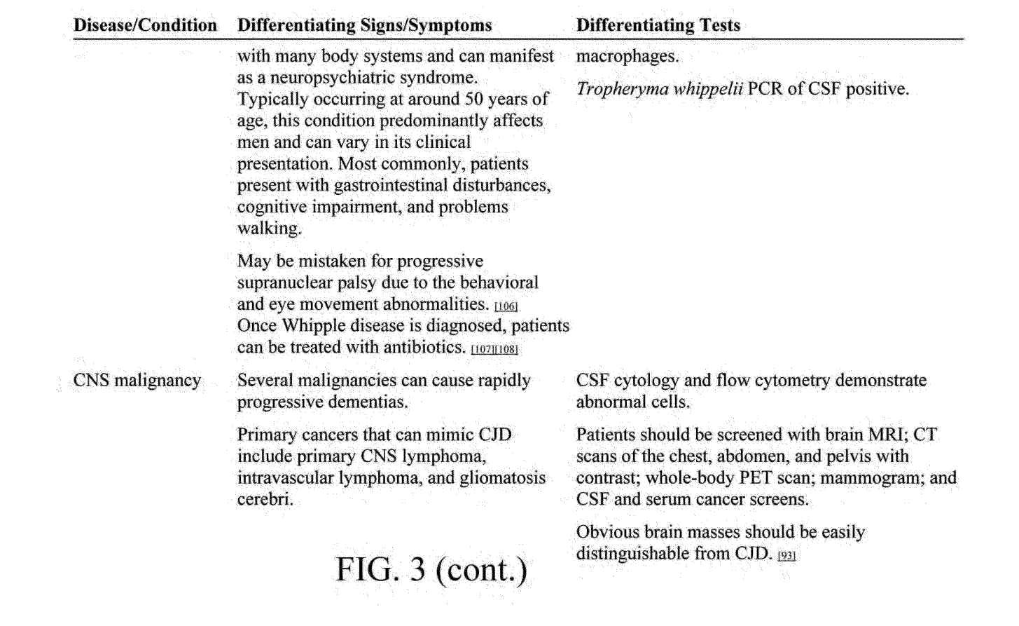

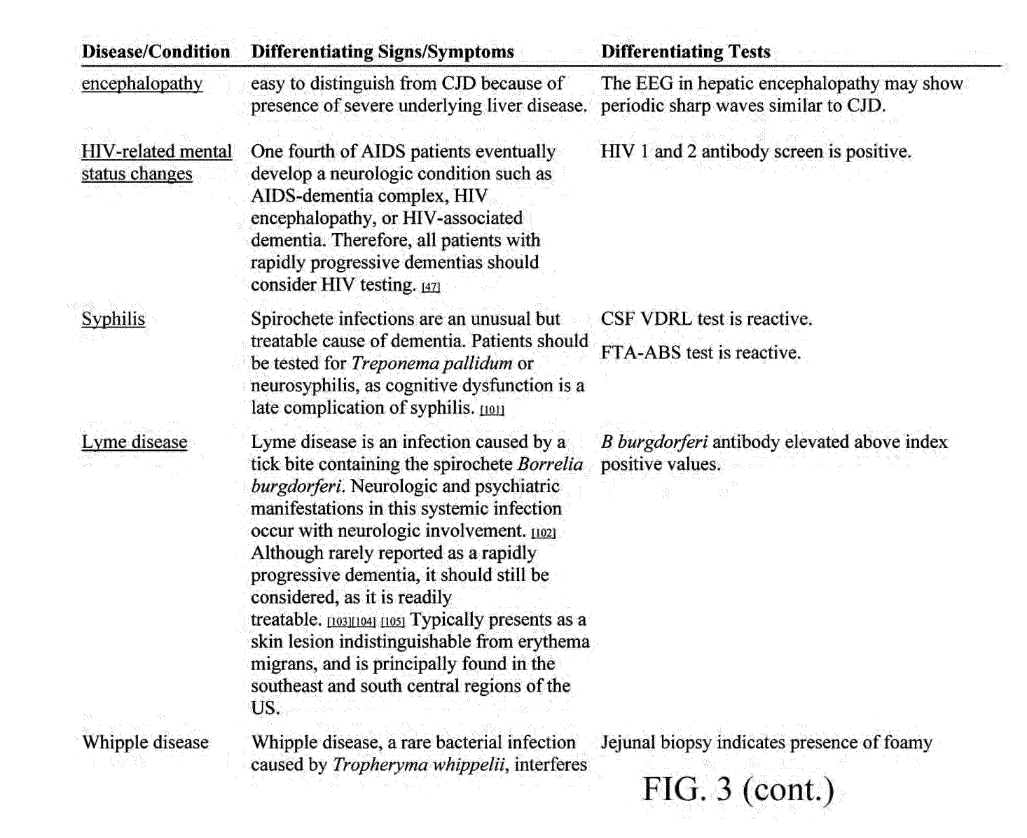

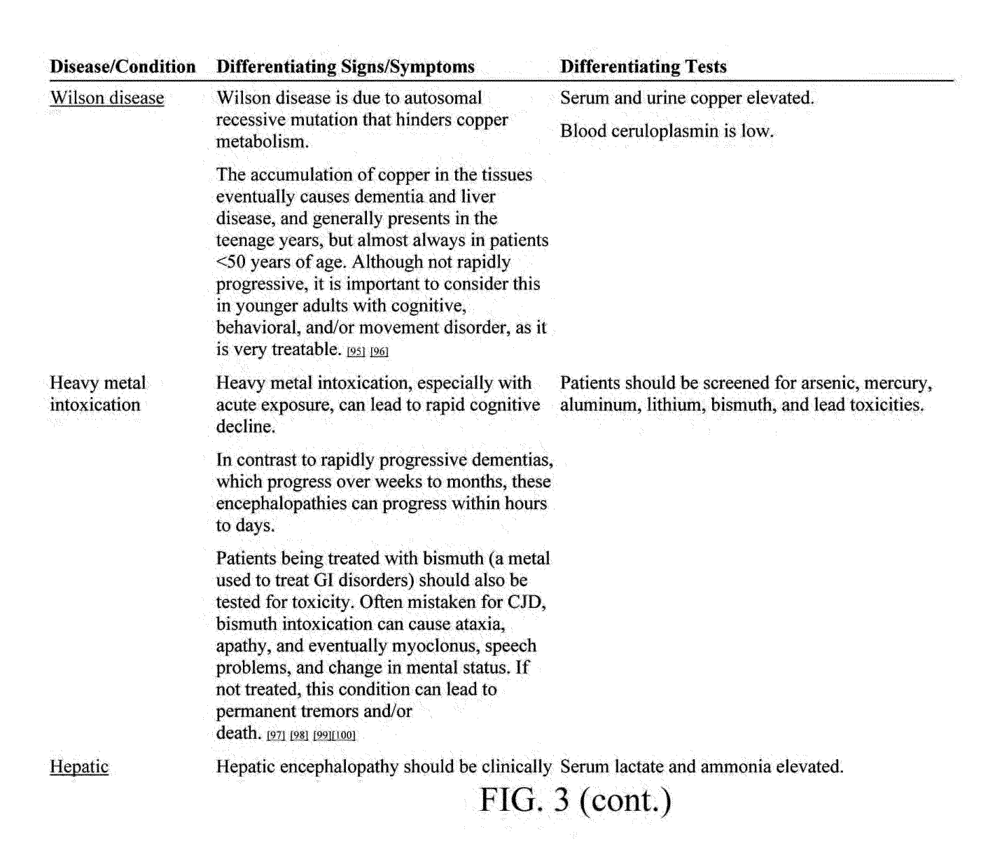

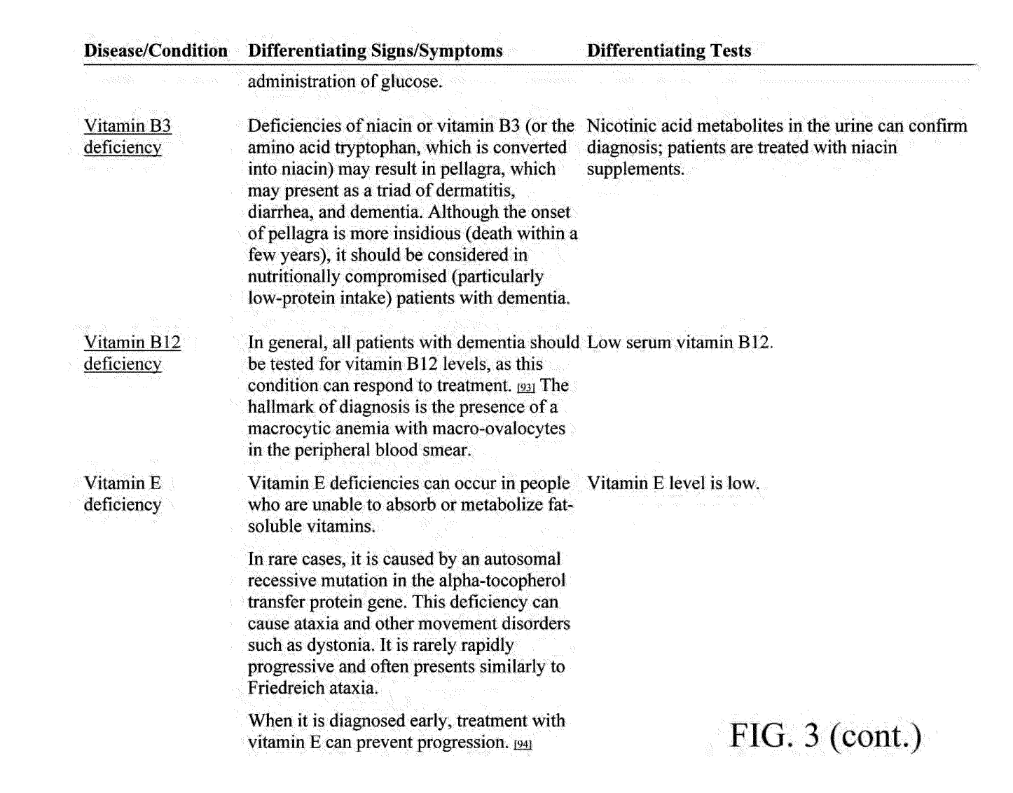

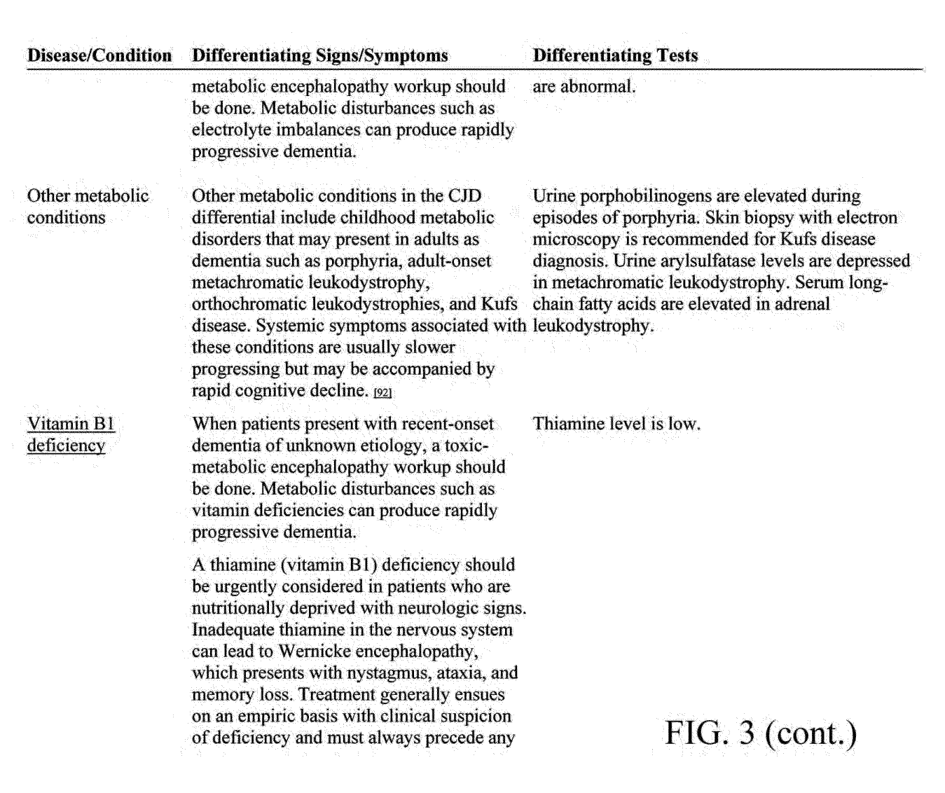

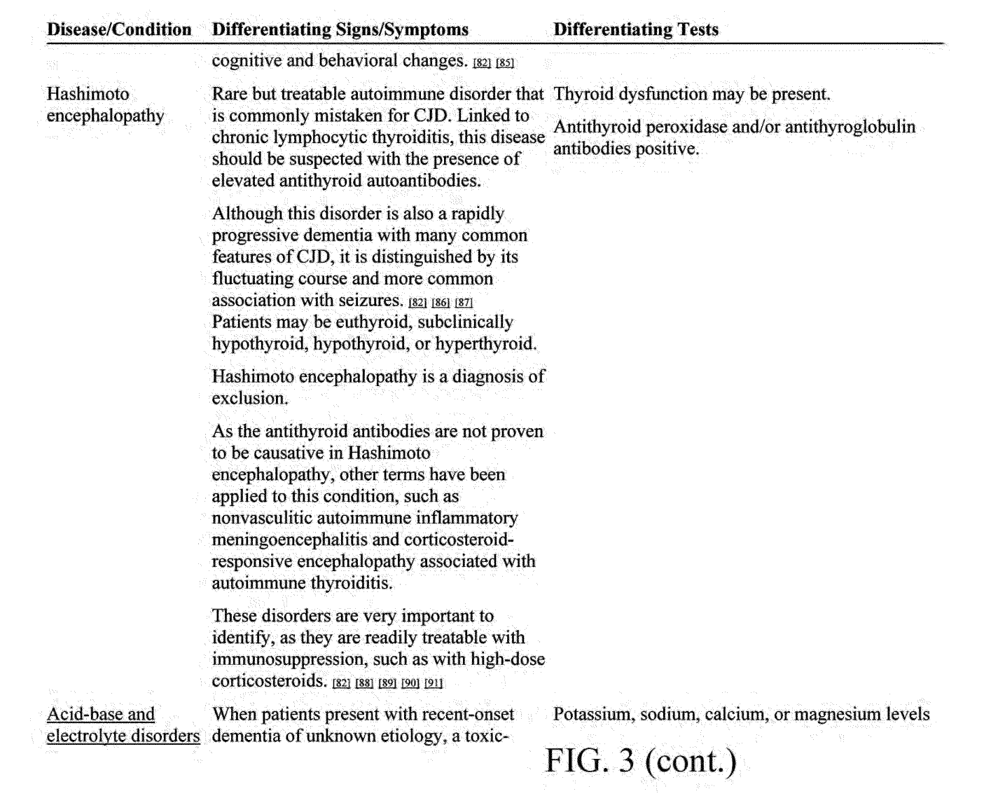

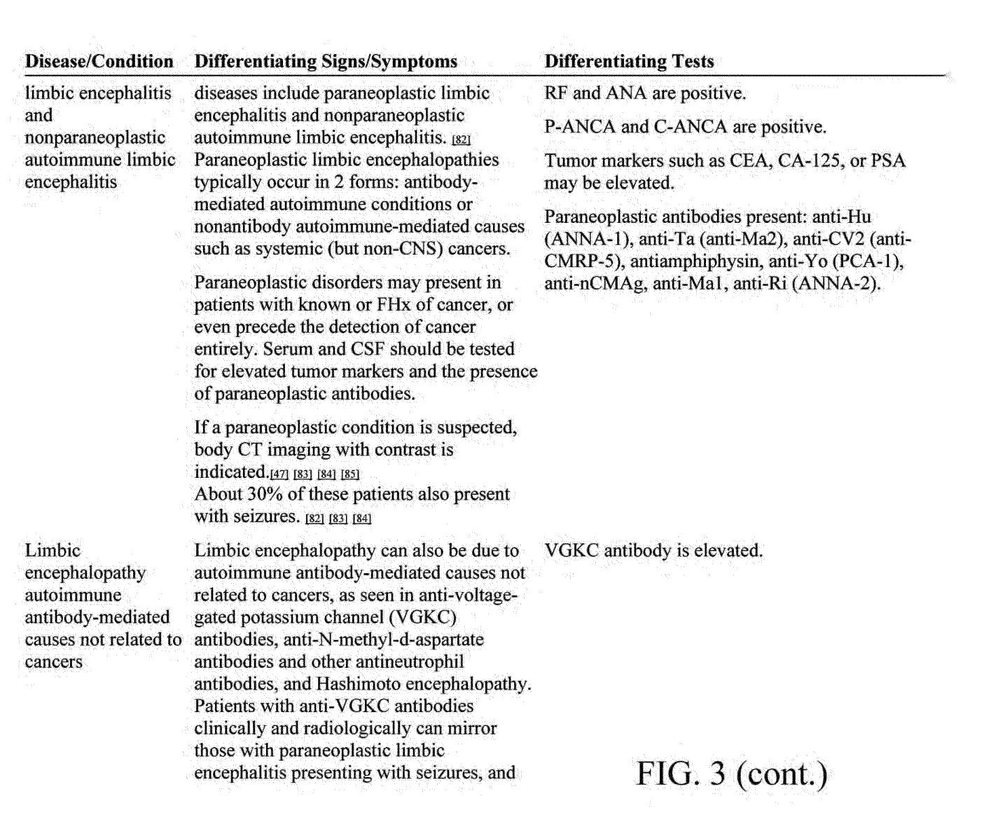

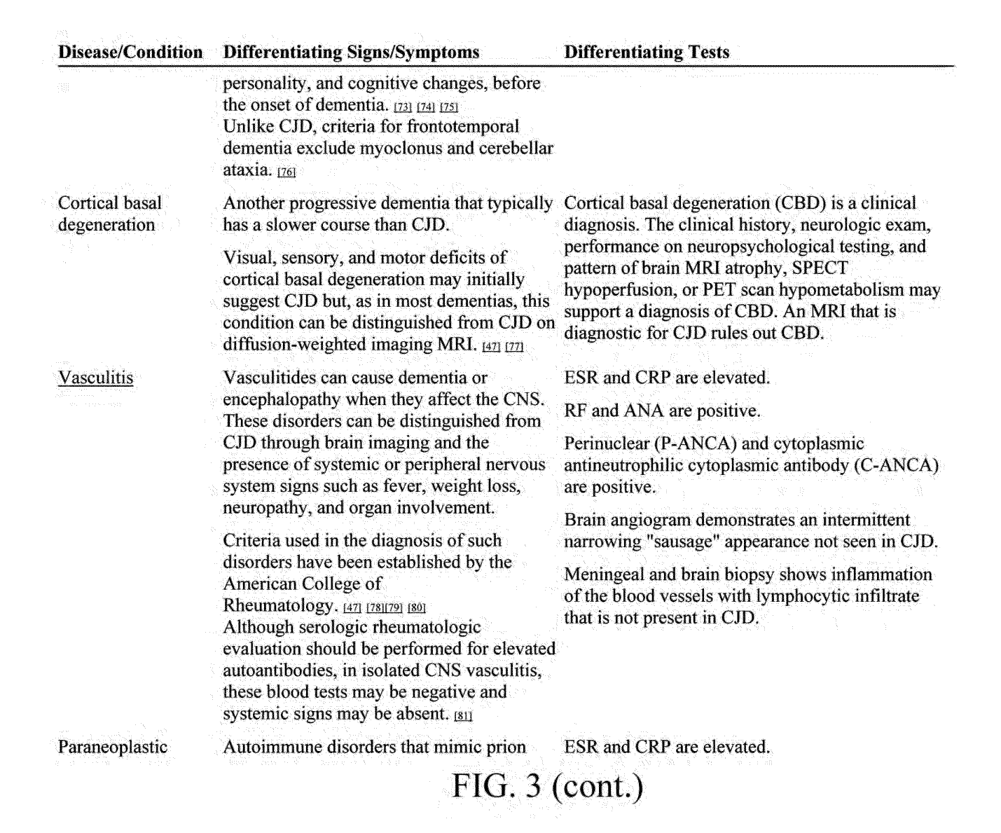

FIG. 3 is an example of entries in the Differential Diagnosis Ruleset used by the analytical engine of the present invention.

In addition, inferences are preferably weighted pursuant to a Likert scale applied to each inference (1=100% certain; 2=Somewhat certain; 3=Neutral; 4=Somewhat uncertain; 5=unclear). The Likert scale may be used to validate the existence of a particular condition to 100% certainty according to clinically accepted standards.

Had the above-described physician begun with a psychiatric assessment, or psychological screening for the purpose of making a diagnosis, they would find dementia and begin more comprehensive psychiatric testing to determine the cause. The physician would not have considered potential underlying physiological problems unless as a last resort, and even then it would have required significant skill and experience to recognize and pursue this line of thinking As a result, a mis-diagnosis would have been likely to result.

It should now be apparent that the above-described invention provides more efficient and effective methods of psychiatric assessment by pre-screening for underlying physical conditions related to psychiatric disorders, via a predetermined battery of tests to yield a matrix of physiological test results, plus a weighted analysis/correlation of said matrix to neurological diagnoses that is capable of software implementation. The present invention is based on the premise that psychiatric disorders are often caused by underlying physiological problems such as neurotoxic disorders, metabolic/endocrine disorders, genetic issues, disease and the like, and that a differential (blood, urine, genetics) physical examination should be an integral part of a comprehensive psychiatric assessment.

Those skilled in the art will understand that various modifications and variations can be made in the present invention without departing from the spirit or scope of the invention. It is to be understood, therefore, that the invention may be practiced otherwise than as specifically set forth in the appended claims.

What is claimed is:

1. A method for pre-screening a plurality of underlying physiological conditions to a manifest neurological condition prior to psychiatric assessment, comprising the steps of:
compiling a computer database including a cross-reference of assay results with physiological conditions, and a cross-reference of physiological conditions with neurological markers, thereby indirectly correlating said assay results with one or more of neurological markers;
a physician administering a predetermined battery of tests including a plurality of blood test assays, a plurality of urine test assays, a plurality of stool test assays, and a plurality of genetic test assays on a hair sample;
entering test results from said predetermined battery of tests into a computer form;
differentially correlating said entered test results from said plurality of blood test assays, plurality of urine test assays, plurality of stool test assays, and said plurality of genetic test assays to one or more underlying physical conditions;
secondarily correlating said underlying physical conditions to a symptomatic neurological disorder;
said physician diagnosing said symptomatic neurological disorder based on said differential and secondary correlation steps.

2. The method for pre-screening a plurality of underlying physiological conditions to a manifest neurological condition prior to psychiatric assessment according to claim 1, wherein said step of differentially correlating further comprises correlating an entered test result from said plurality of blood test assays to an underlying physical condition, and correlating an entered test result from said plurality of urine test assays to the same underlying physical condition.

3. The method for pre-screening a plurality of underlying physiological conditions to a manifest neurological condition prior to psychiatric assessment according to claim 2, wherein said step of secondarily correlating said underlying physical conditions to a symptomatic neurological disorder is based on said differential correlation of the entered test result from said plurality of blood test assays in combination with said entered test result from said plurality of urine test assays.

4. The method for pre-screening a plurality of underlying physiological conditions to a manifest neurological condition prior to psychiatric assessment according to claim 2, wherein said step of correlating said plurality of blood test assays to an underlying physical condition includes assigning a first Likert scale weighting, and said step of correlating an entered test result from said plurality of urine test assays to the same underlying physical condition includes assigning a second Likert scale weighting.

5. An apparatus for pre-screening a plurality of underlying physiological conditions to a manifest neurological condition prior to psychiatric assessment, comprising:
a processor and memory for storing software comprising computer instructions stored on non-transitory memory for carrying out the steps of,
a computer database including a cross-reference of assay results with physiological conditions, and a cross-reference of physiological conditions with neurological markers, thereby indirectly correlating said assay results with one or more of neurological markers;
software comprising computer instructions stored on non-transitory memory for carrying out the steps of,
entering test results from a predetermined battery of tests including a plurality of blood test assays, a plurality of urine test assays, a plurality of stool test assays, and a plurality of genetic test assays on a hair sample, into said computer database;
differentially correlating said entered test results from said plurality of blood test assays, plurality of urine test assays, plurality of stool test assays, and said plurality of genetic test assays to one or more underlying physical conditions;
secondarily correlating said underlying physical conditions to a symptomatic neurological disorder;
whereby a physician may diagnose said symptomatic neurological disorder based on said differential and secondary correlation steps.

6. The apparatus for pre-screening a plurality of underlying physiological conditions to a manifest neurological condition prior to psychiatric assessment according to claim 5, wherein said step of differentially correlating further comprises correlating an entered test result from said plurality of blood test assays to an underlying physical condition, and correlating an entered test result from said plurality of urine test assays to the same underlying physical condition.

7. The apparatus for pre-screening a plurality of underlying physiological conditions to a manifest neurological condition prior to psychiatric assessment according to claim 6, wherein said step of secondarily correlating said underlying physical conditions to a symptomatic neurological disorder is based on said differential correlation of the entered test result from said plurality of blood test assays in combination with said entered test result from said plurality of urine test assays.

8. A system for diagnosing a neurological by pre-screening underlying physiological conditions to a prior to psychiatric assessment, comprising:
a web-enabled server computer;
a plurality of remote client computers in communication with said server computer;
a computer database stored on non-transitory computer media on said server computer including a cross-reference of assay results with physiological conditions, and a cross-reference of said physiological conditions with associated neurological markers;
software stored on non-transitory computer media on said server computer for presenting a user-interface accessible at said plurality of remote client computers for entering test results from a predetermined battery of physiological tests including a plurality of blood test assays, plurality of urine test assays, plurality of stool test assays, and said plurality of genetic test assays;
software stored on non-transitory computer media on said server computer for carrying out the steps of,
differentially correlating said entered test results from said plurality of blood test assays, plurality of urine test assays, plurality of stool test assays, and said plurality of genetic test assays to one or more underlying physical conditions;
secondarily correlating said underlying physical conditions to a symptomatic neurological disorder.

9. The system for diagnosing a neurological by pre-screening underlying physiological conditions prior to psychiatric assessment according to claim 8, wherein said software for differentially correlating said entered test results assigns a Likert scale weighting to said correlations.
